(19) United States
(12) Patent Application Publication
(10) Pub. No.: US 2024/0400147 A1
(43) Pub. Date: Dec. 5, 2024

(54) BATTERY BOX ASSEMBLY

(71) Applicant: Indian Motorcycle International, LLC, Medina, MN (US)

(72) Inventors: Arif Keskin, Lommiswil (CH); Clark D. Davis, Shoreview, MN (US)

(73) Assignee: Indian Motorcycle International, LLC, Medina, MN (US)

(21) Appl. No.: 18/691,083

(22) PCT Filed: Sep. 9, 2022
(86) PCT No.: PCT/US2022/076185

§ 371 Date: Mar. 12, 2024

Related U.S. Application Data
(60) Provisional application No. 63/243,487, filed on Sep. 13, 2021.

(51) Int. Cl. B62J 43/28; H01M 50/202; H01M 50/249; H01M 50/271; H01M 50/588; H01M 50/591

(52) U.S. Cl. CPC B62J 43/28; H01M 50/202; H01M 50/249; H01M 50/271; H01M 50/588; H01M 50/591; H01M 2220/20

(57) ABSTRACT

Aspects of the present disclosure relate to a battery support for a battery. As an example, the battery support comprises a first frame, a second frame spaced apart from the first frame to define a cavity, and a movable frame member positionable in the cavity. The movable frame member comprises a first interface configured to interface with a corresponding second interface of the first frame when the movable frame member is moved in a first direction toward the first frame. The movable frame member cooperates with the second frame to define a battery cavity sized to receive the battery and to restrict movement of the movable frame member in a second direction opposite the first direction when the battery is received by the battery cavity.

### RELATED APPLICATIONS

The present disclosure claims priority to U.S. Provisional Patent Application No. 63/243,487, filed Sep. 13, 2021, titled BATTERY BOX ASSEMBLY, docket PLR-12-29857.01P-US, the entire disclosure of which is expressly incorporated by reference herein.

### BACKGROUND OF THE DISCLOSURE

Affixing a battery box and associated parts may introduce additional complexity to the manufacture of a vehicle, especially in space-constrained scenarios. For example, a battery box assembly having a dense configuration of parts may utilize specialized or varied tools during assembly, or may entail lengthy and/or tedious manufacturing steps. In other examples, a comparatively less dense configuration may be used instead so as to avoid such complexities.

It is with respect to these and other general considerations that embodiments have been described. Also, although relatively specific problems have been discussed, it should be understood that the embodiments should not be limited to solving the specific problems identified in the background.

### SUMMARY OF THE DISCLOSURE

Aspects of the present disclosure relate to a battery support for a battery. As an example, the battery support comprises a first frame, a second frame spaced apart from the first frame to define a cavity, and a movable frame member positionable in the cavity. The movable frame member comprises a first interface configured to interface with a corresponding second interface of the first frame when the movable frame member is moved in a first direction toward the first frame. The movable frame member cooperates with the second frame to define a battery cavity sized to receive the battery and to restrict movement of the movable frame member in a second direction opposite the first direction when the battery is received by the battery cavity.

In another example, a vehicle having a battery is provided. The vehicle comprises a plurality of ground engaging members and a frame supported by the plurality of ground engaging members. The frame includes a first midframe having a first interface defined on an interior side of the first midframe and a second midframe, wherein the first midframe and the second midframe are on opposing sides of a longitudinal centerline of the vehicle. The vehicle further comprises a movable frame member comprising a second interface configured to interface with the first interface of the first midframe when the movable frame member is moved in a first direction toward the first midframe and away from the longitudinal centerline. The movable frame member cooperates with the second midframe to define a battery cavity sized to receive the battery and to restrict a movement of the movable frame member in a second direction opposite the first direction when the battery is received by the battery cavity.

In yet another example, a battery support for a battery is provided. The battery support comprising a first movable frame member; a second movable frame member that cooperates with the first movable frame member to define a battery cavity sized to receive the battery; and a cover that mechanically couples to the first movable frame member and the second movable frame member to retain the battery within the battery cavity. The cover includes a positive terminal feature positioned to cover a positive terminal of the battery; a negative terminal feature that restricts removal of the cover when a negative terminal of the battery is electrically connected; and a busbar feature configured to permit a busbar to extend from the battery cavity, thereby enabling an electrical connection to the positive terminal of the battery via the busbar when the cover is coupled to the first movable frame member and the second movable frame member.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates a side view of a vehicle having a battery box assembly according to aspects of the present disclosure.

FIG. 1B illustrates top down view of the vehicle of FIG. 1A.

FIG. 2 illustrates an exploded perspective view of the example battery box assembly.

FIG. 3 illustrates a rear left perspective view of an example battery box assembly.

FIG. 4 illustrates a rear view of the example battery box assembly.

FIG. 5 illustrates a top down view of the example battery box assembly.

FIG. 6 illustrates a bottom up view of the example battery box assembly.

FIG. 7 illustrates another top down view of the example battery box assembly.

FIG. 8 illustrates a right view of the example battery box assembly.

FIG. 9 illustrates a right perspective view of a movable frame member of the example battery box assembly.

FIG. 10 illustrates a left view of the movable frame member of FIG. 9.

FIG. 11 illustrates a front perspective view of the movable frame member of FIG. 9.

FIG. 12 illustrates another front perspective view of the movable frame member of FIG. 9.

FIG. 13 illustrates a perspective view of a cover of the example battery box assembly.

FIG. 14 illustrates another perspective view of the cover of FIG. 13.

FIG. 15 illustrates a detail view of the positive terminal feature of the cover in FIGS. 13 and 14.

FIG. 16 illustrates a detail view of the negative terminal feature of the cover in FIGS. 13 and 14.

FIG. 17 illustrates a front perspective view of the example battery box assembly according to aspects of the present disclosure, where a busbar is electrically connected to the positive terminal of the battery disposed therein.

FIG. 18 illustrates a top perspective view of the example battery box assembly of FIG. 17.

FIG. 19 illustrates a rear perspective view of the example battery box assembly of FIGS. 17 and 18.

### DETAILED DESCRIPTION OF THE DRAWINGS

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. The following detailed description is therefore not to be taken in a limiting sense, and the scope of the present disclosure is defined by the appended claims and their equivalents.

In examples, a battery box assembly and associated parts may be bolted to a chassis of a vehicle. For example, a motorcycle may have such a battery box assembly attached at the midframe of the vehicle. Space may be limited in such an example, and a denser configuration may therefore be preferential. However, this may introduce additional complexity and time to the manufacturing process, for example requiring the use of specialized and/or varied tools, as well a specific sequence of potentially tedious or complicated assembly steps.

Accordingly, aspects of the present disclosure relate to a battery box assembly in which at least one movable frame member is used to retain one or more parts between the movable frame member and the frame of the vehicle. For instance, the movable frame member may be positionable within a cavity defined between a left midframe and a right midframe of the vehicle. As an example, the movable frame member may comprise one or more pegs that are received by corresponding cups of the vehicle frame (each of which may be referred to herein an “interfaces,” e.g., of an associated movable frame member or frame/midframe). The pegs may enable the movable frame member to move laterally toward the vehicle frame, such that the parts are retained accordingly. In some instances, a peg may have an associated isolator, which may reduce the transfer of vibrations from the frame to the movable frame member. The movable frame member may further at least partially define a battery cavity, such that installation of the battery in the battery cavity restricts lateral movement of the movable frame member.

Thus, aspects of the present disclosure simplify manufacture of a battery box assembly, where use of the disclosed movable frame member enables retention of parts between a vehicle frame and the movable frame member, while the movable frame member is ultimately fixed in place by a battery. Example parts include, but are not limited to, structural parts or electrical parts. The assembly process therefore need not require fasteners or specialized tools. Further, while a battery is disclosed as fixing the position of the movable frame member, it will be appreciated that any of a variety of other objects may be used, such as a cover or a temporary fixture, among other examples. In some examples, the battery may further be retained within the disclosed battery box assembly by a cover, for example that mechanically couples to the movable frame member.

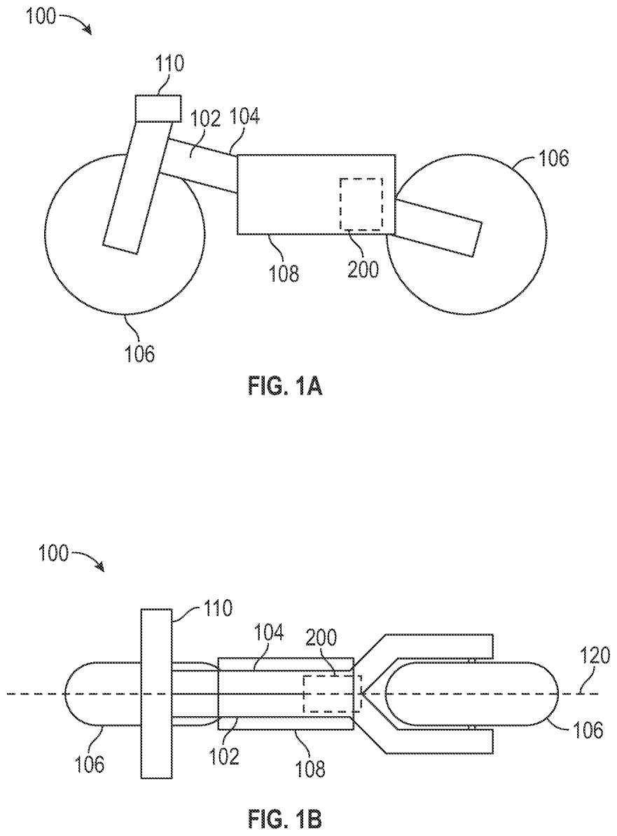

FIGS. 1A and 1B illustrate a side view and a top down view, respectively, of vehicle 100 having battery box assembly 200 according to aspects of the present disclosure. As illustrated, vehicle 100 comprises two ground engaging members 106, a frame comprising left midframe 102 and right midframe 104, seat assembly 108, and handlebars 110. In examples, an operator may straddle seat assembly 108 and utilize handlebars 110 to control a speed and/or direction of vehicle 100. For example, vehicle 100 may be comprise a prime mover (not pictured) controllable by the operator using a throttle control of handlebars 110. Similarly, handlebars 110 may comprise one or more brake controls to control a breaking system of vehicle 100.

As shown in FIG. 1B, left midframe 102 and right midframe 104 are mechanically coupled along longitudinal centerline 120 and are supported by ground engaging members 106. Battery box assembly 200 is illustrated using dashed lines to indicate that it may be internal to vehicle 100. For example, battery box assembly 200 may be installed and/or positionable within a cavity defined by left midframe 102 and right midframe 104 (e.g., during the assembly process). In some instances, seat assembly 108 may further be installed over the region in which battery box assembly 200 is located.

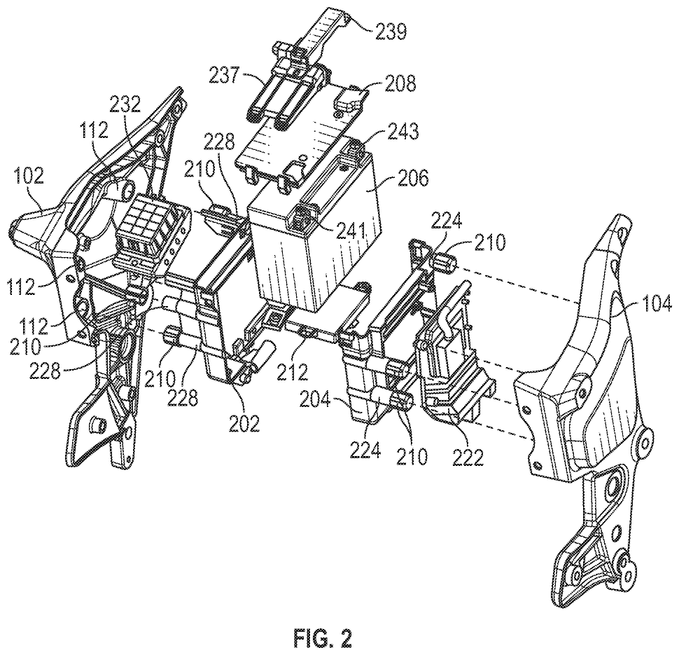

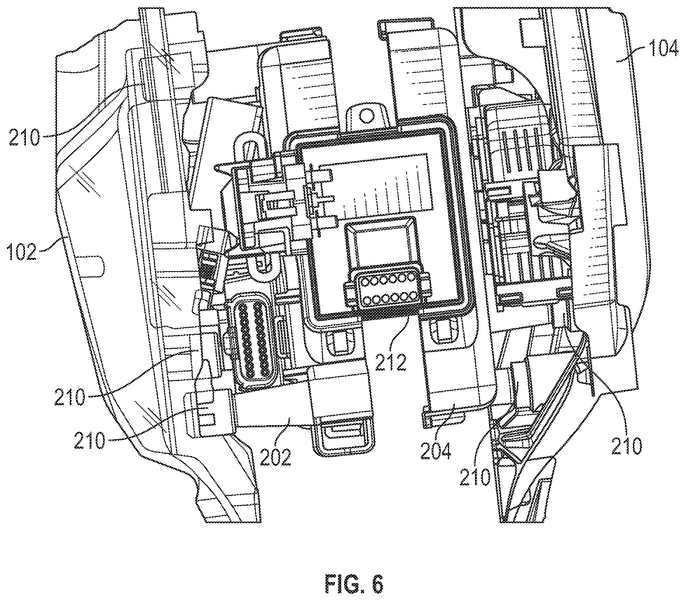

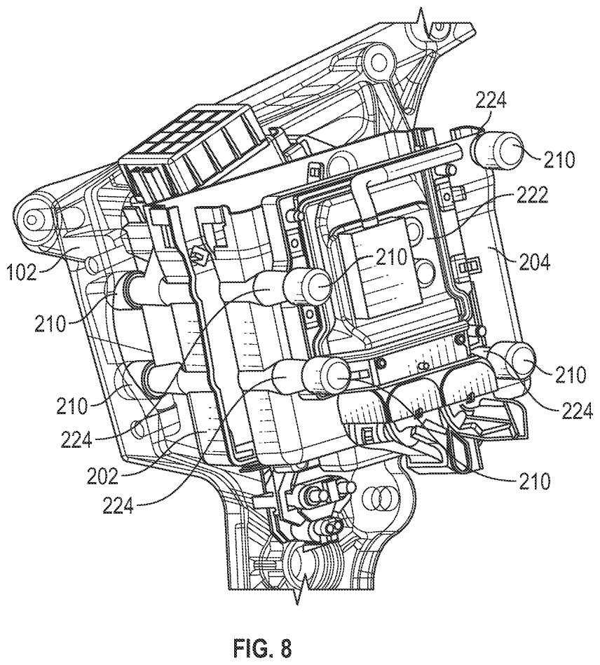

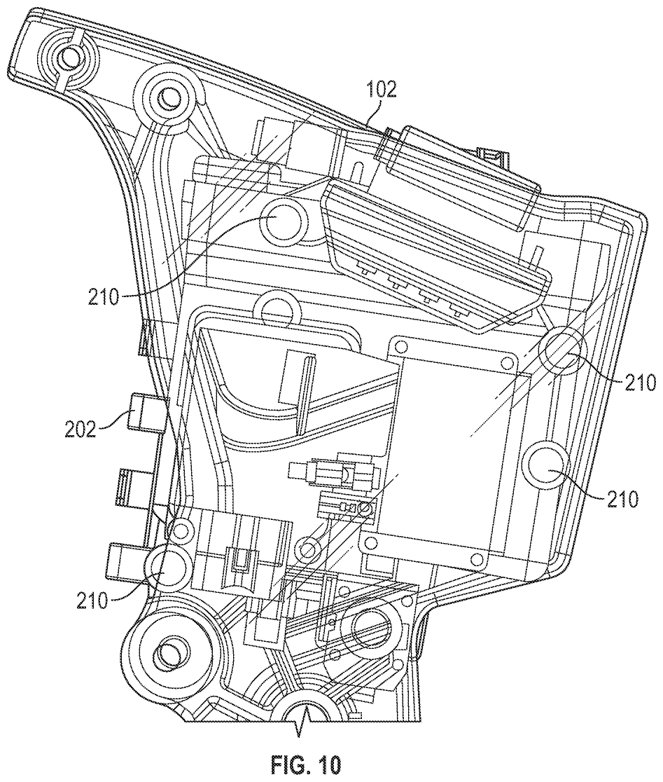

Additional aspects of battery box assembly 200 are described below with respect to FIGS. 2-16. The disclosed battery box assembly may also be referred herein to as a battery support. It will be appreciated that while a motorcycle having two ground engaging members located along longitudinal centerline 120 is provided as an example vehicle 100 with which the described battery box assembly may be used, such aspects may similarly be applicable to any of a variety of other vehicles (e.g., having fewer or additional ground engaging members in similar or different configurations).

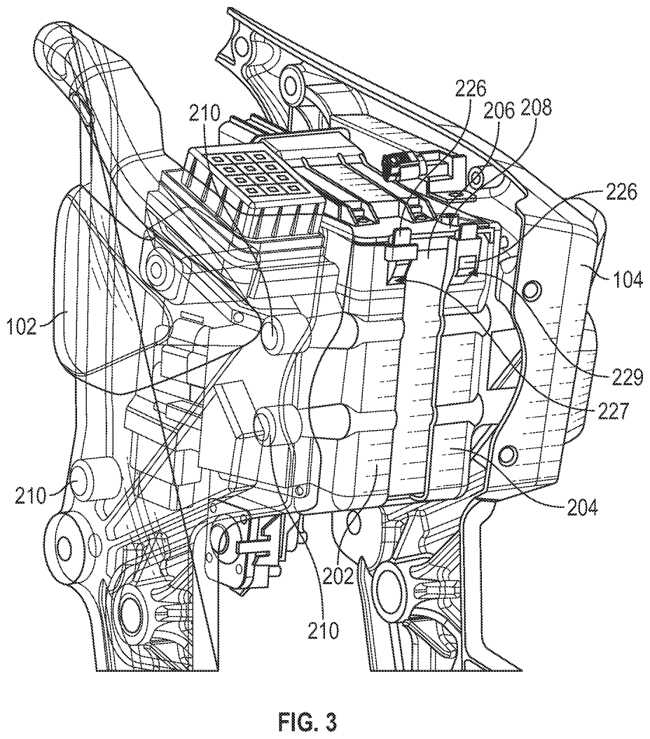

FIGS. 2 and 3 illustrate a rear left perspective view and an exploded view, respectively, of an example battery box assembly 200 according to aspects of the present application. As illustrated, battery box assembly 200 comprises left movable frame member 202, right movable frame member 204, and cover 208, in which battery 206 is disposed. As illustrated, battery 206 includes negative terminal 241 and positive terminal 243. Battery box assembly 200 is provided as an example in which multiple movable frame members 202 and 204 are used. However, it will be appreciated that additional of fewer movable frame members may be used. For example, right movable frame member 204 may be omitted, such that battery 206 is instead retained between left movable frame member 202 and right midframe 104. As another example, one or more of movable frame members 202 and/or 204 may be split into two or more such members, such that additional movable frame members are used to retain battery 206 within battery box assembly 200 and/or one or more parts (e.g., parts 222 and 232) external to battery box assembly 200.

With reference to left movable frame member 202, FIGS. 2 and 3 show left movable frame member 202 interfacing with left midframe 102. More specifically, left movable frame member 202 comprises pegs 228, which interface with cups 112 of left midframe 102. Isolators 210 are illustrated between pegs 228 and cups 112. For example, each isolator 210 may be a rubber or foam sleeve that covers at least a part of an associated peg 228, thereby reducing the transfer of vibrations between left midframe 102 and left movable frame member 202.

It will be appreciated that any of a variety of isolators may be used and need not be a sleeve. For example, isolators 210 may be washers or standoffs in other examples. Further, it will be appreciated that one or more fasteners may be used to mechanically couple a movable frame member to a midframe, for example in addition to or as an alternative to the illustrated use of cups 112 in conjunction with pegs 228 (and isolators 210).

As used herein, an interface of a movable frame member may interface with an interface of a midframe. Illustratively, peg 224 or peg 228 may each be referred to as an interface of a movable frame member (e.g., in an instance where isolators 210 are omitted or a pre-installed within an associated cup). Similarly, an associated cup of a midframe may similarly be referred to as an interface of the midframe. As another example, peg 228 in combination with isolator 210 may be referred to as an interface of left movable midframe member 202.

Part 232 is retained between left midframe 102 and left movable frame member 202. In some examples, part 232 may first be mechanically coupled (e.g., using one or more fasteners or a friction fit) with left midframe 102 or left movable frame member 202. In other examples, part 232 may be retained in place largely as a result of the fit between left midframe 102 and left movable frame member 202 when left movable frame member 202 is moved laterally into left midframe 102.

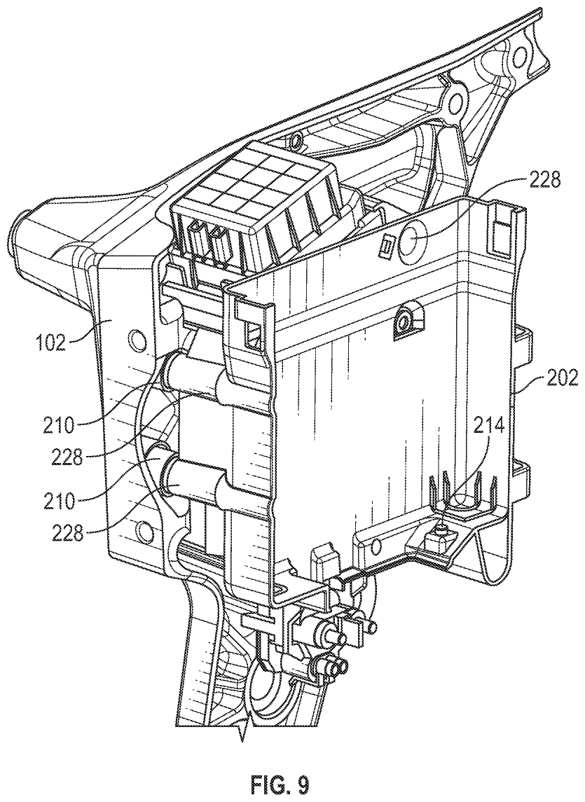

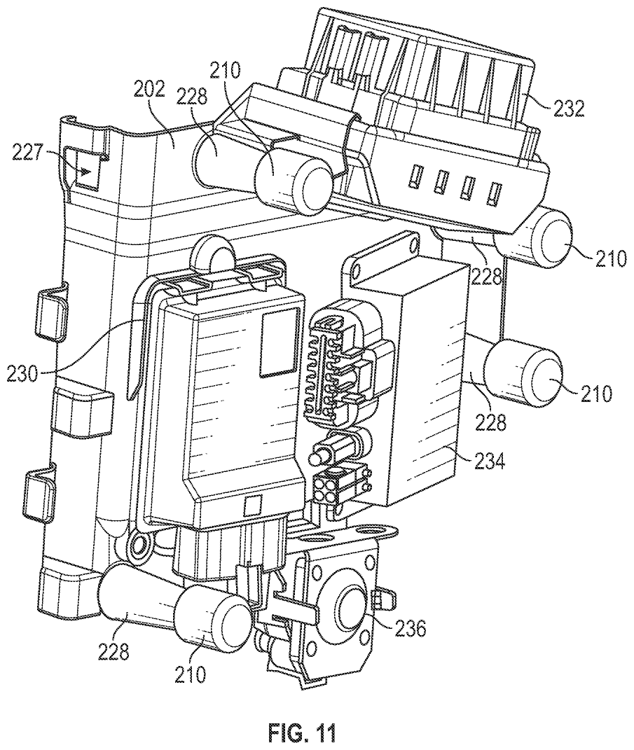

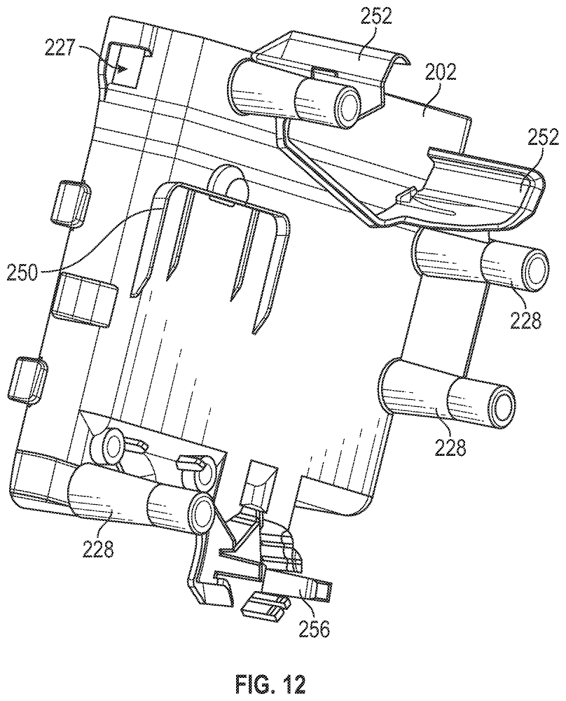

FIGS. 9-12 depict additional detail with respect to left movable frame member 202. For instance, FIG. 11 illustrates additional parts 230, 234, and 236 mechanically coupled to left movable frame member 202, while FIG. 12 illustrates example features 250, 252, and 256 of left movable frame member 202 that may be used to retain parts 230, 232, and 236, respectively. For instance, features 250, 252, and 256 may cooperate with left midframe 102 to retain a corresponding part or, as another example, the part may be clipped (e.g., as illustrated by feature 256) or fastened (e.g., as may be the case for part 234) to left movable frame member 202. Thus, it will be appreciated that a part may be retained according to any of a variety of techniques.

With reference to FIGS. 2, 3, and 8, right movable frame member 204 interfaces with right midframe 104, such that part 222 is retained between right midframe 104 and right movable frame member 204. Right movable frame member 204 comprises pegs 224, which interface with cups of right midframe 104 via isolators 210. In some examples, part 222 may first be mechanically coupled (e.g., using one or more fasteners or a friction fit) with right midframe 104 or right movable frame member 204.

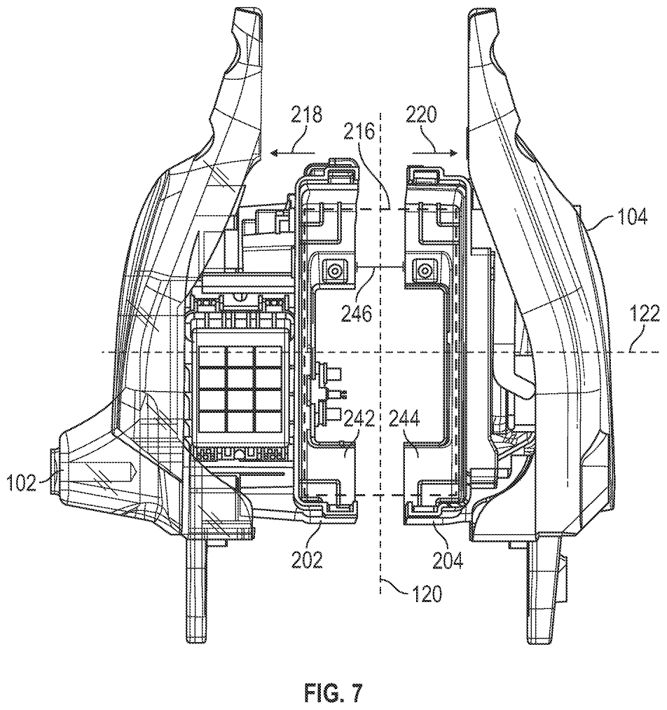

When left movable frame member 202 and right movable frame member 204 are in position with respect to left midframe 102 and right midframe 104, respectively, they cooperate to form a battery cavity 216 (see FIG. 7) in which battery 206 is disposed. Movable frame members 202 and 204 may be movable during assembly (e.g., to enable installation and/or retention of parts 222, 230, 232, 234, and 236). Movable frame members 202 and 204 may each be moved laterally toward midframe 102 or 104 (as illustrated by arrows 218 and 220 in FIG. 7), respectively, such that pegs 228 and 224 are each within an associated cup of the corresponding midframe. Subsequently, placement of battery 206 within battery cavity 216 (e.g., between left movable frame member 202 and right movable frame member 204) limits lateral movement of left movable frame member 202 and right movable frame member 204, such that they may no longer be removed from left midframe 102 and right midframe 104, respectively. Thus, installation of battery 206 within battery box assembly 200 may effectively “lock” movable frame members 202 and 204 (and associated parts 222, 230, 232, 234, and/or 236) in place, such that they may not be removed from midframes 102 and 104 without removal of battery 206.

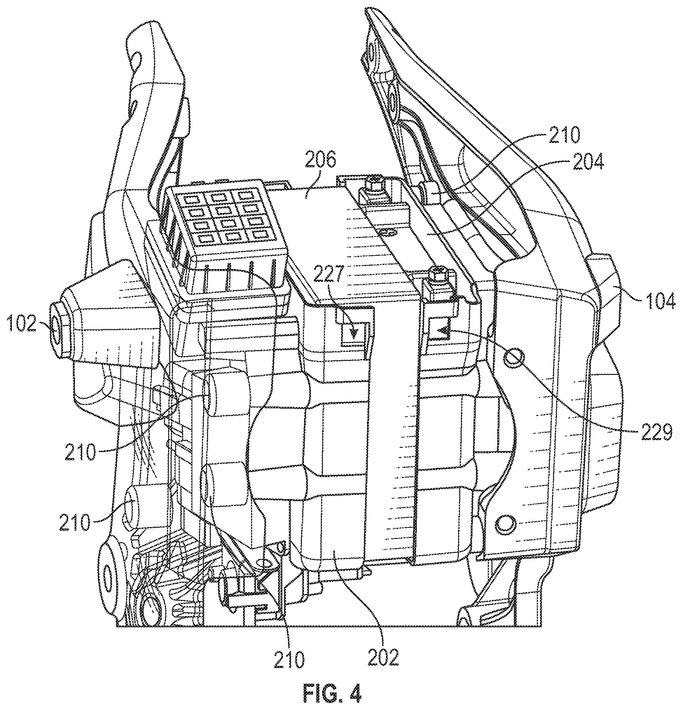

FIG. 4 illustrates an example in which cover 208 of battery box assembly 200 is removed. While battery 206 may be retained within battery cavity 216 by gravity and/or friction in some examples, cover 208 further limits movement of battery 206 within battery cavity 216, for example to prevent removal (inadvertent or otherwise) of battery 206 from battery cavity 216. Cover 208 includes retention clips 226 that interface with feature 227 of left movable frame member 202 and feature 229 of right movable frame member 204.

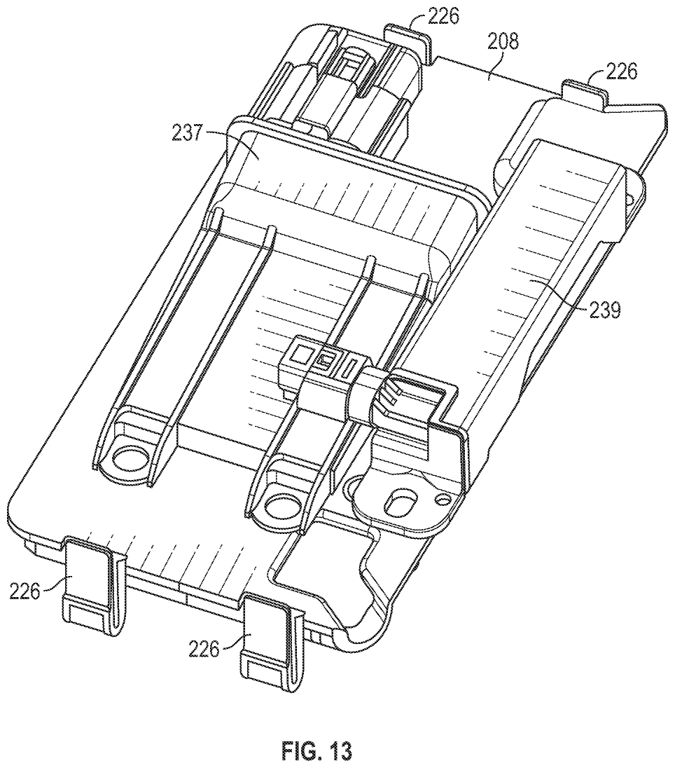

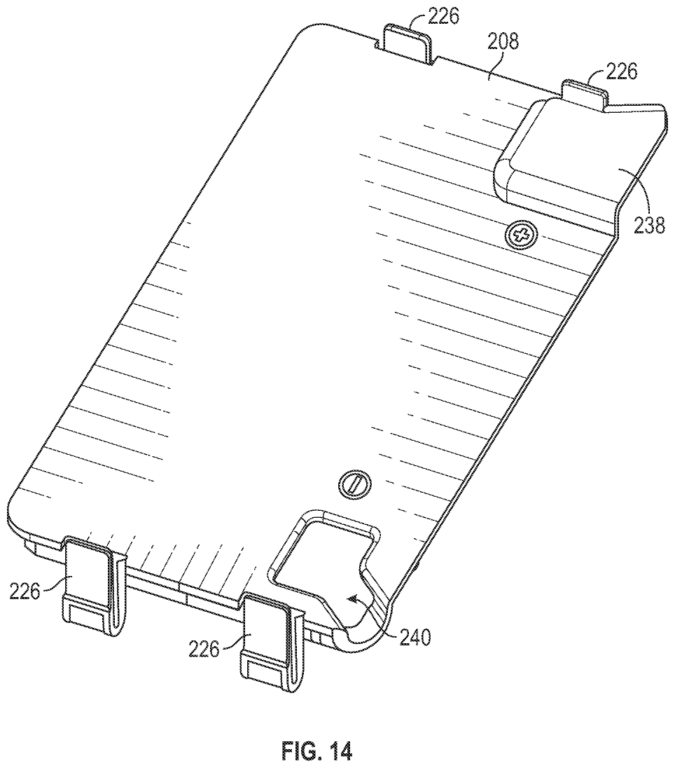

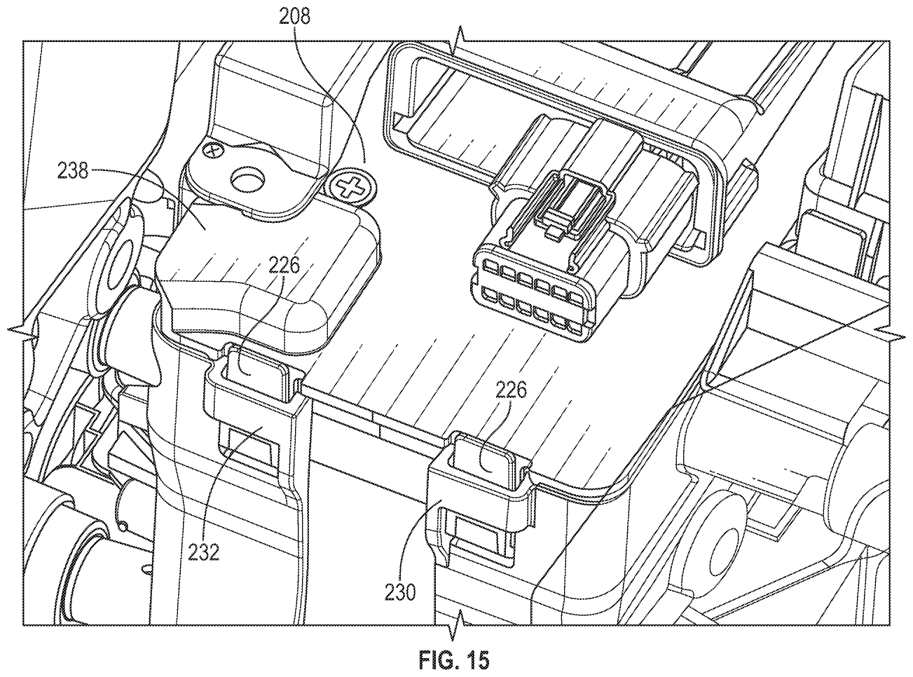

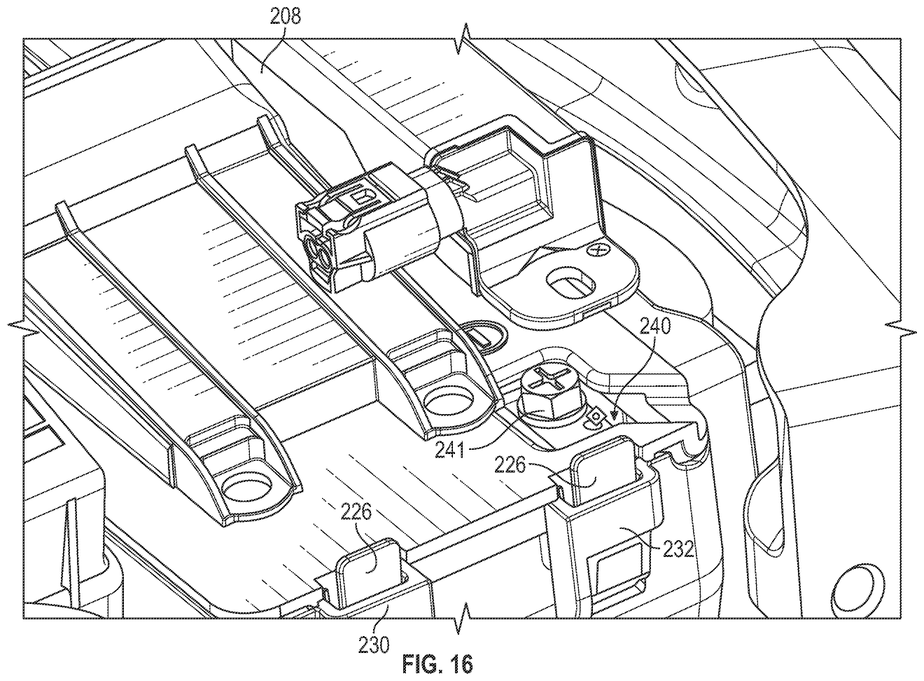

FIGS. 13-16 depict additional detail with respect to cover 208. As illustrated in FIG. 13, parts 237 and 239 are mechanically coupled to cover 208, for example using one or more fasteners or retention clips. Turning now to FIG. 14, cover 208 includes positive terminal feature 238 and negative terminal feature 240. In examples, positive terminal feature 238 is positioned to cover a positive terminal of battery 206 when cover 208 is mechanically coupled to left movable frame member 202 and right movable frame member 204, thereby reducing the likelihood of inadvertent contact with the positive terminal. Negative terminal feature 240 is such that an electrical connection to the negative terminal 241 (see FIG. 16) of battery 206 is made after cover 208 is mechanically coupled to movable frame members 202 and 204, thereby preventing removal of cover 208 while the negative terminal is electrically connected. FIG. 15 provides a detail view of positive terminal feature 238, while FIG. 16 provides a detail view of negative terminal feature 240 in association with negative terminal 241 of battery 206.

Similar to battery 206, cover 208 may additionally or alternatively lock movable frame members 202 and 204 in place. In other instances, a temporary fixture (not pictured) may be placed within battery cavity 216 to restrict the movement of movable frame members 202 and 204, such as a piece of cardboard or foam, among other examples. For instance, such a temporary fixture may be used during transport of vehicle 100, as battery 206 may not be installed during manufacture and may instead be installed after delivery has been completed. As another example, one or more fasteners may additionally or alternatively be used to fasten movable frame member 202 and/or 204 to midframe 102 or 104, respectively, thereby locking them in place even absent battery 206 or other similar fixture.

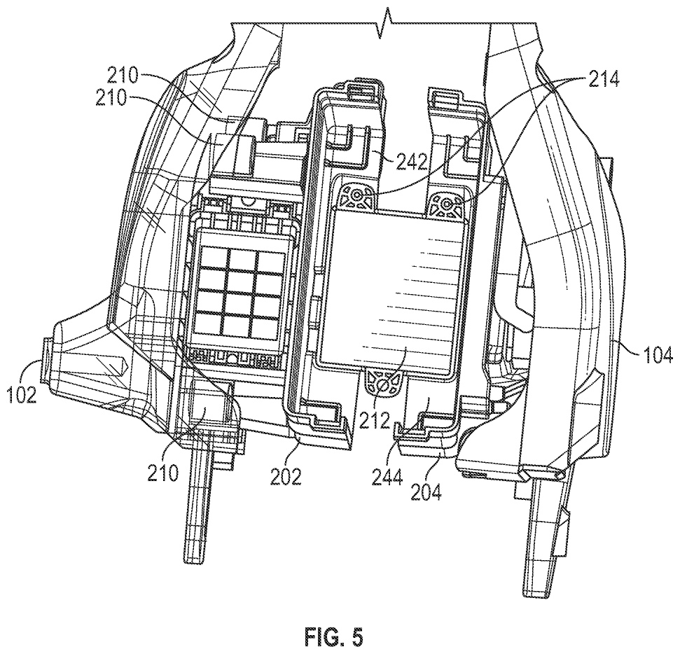

As shown in FIGS. 5-7, left movable frame member 202 and right movable frame member 204 each have lower lip 242 and 244, respectively, which define the lower surface of battery cavity 216. In examples, bottom part 212 is included, which further defines the lower surface of battery cavity 216. As illustrated, left movable frame member 202 and right movable frame member 204 each include a pin 214, which interfaces with corresponding features of bottom part 212, thereby restricting its lateral and longitudinal movement. Similar to movable frame members 202 and 204, vertical movement of bottom part 212 is ultimately restricted as a result of installation of battery 206 within battery cavity 216 (or, in other examples, any of a variety of other fixtures). It will be appreciated that, in other examples, bottom part 212 may be retained using one or more fasteners in addition to, or as an alternative to, one or more pins 214. As a further example, pins 214 may be omitted, such that bottom part 212 lays between left movable frame member 202 and right movable frame member 204 and is ultimately fixed in place by battery 206 when disposed within battery cavity 216.

With reference to FIG. 7, left movable frame member 202 may be installed into left midframe 102 by moving left movable frame member 202 laterally as illustrated by arrow 218. Similarly, right movable frame member 204 may be installed into right midframe 104 by moving right movable frame member 204 laterally as illustrated by arrow 220. Arrows 218 and 220 are parallel to lateral axis 122, while longitudinal centerline 120 illustrates a longitudinal axis. During installation, left movable frame member 202 and right movable frame member 204 may each be lowered vertically (e.g., perpendicular to both longitudinal centerline 120 and lateral axis 122) between left midframe 102 and right midframe 104 prior to their lateral installation as described above. Thus, the illustrated gap 246 between left movable frame member 202 and right movable frame member 204 in their installed positions may correspond to a depth at which pegs 228 and 224 interface with cups of left midframe 102 and right midframe 104, respectively. Once battery 206 (and/or another fixture) is disposed within battery cavity 216, movement of movable frame members 202 and 204 is restricted (e.g., in the direction of arrows 220 and 218, respectively).

It will be appreciated that movement along lateral, longitudinal, and/or vertical axes is discussed for illustrative purposes and any of a variety of other axial and/or radial movements may be used in other examples. Further, it will be appreciated that the disclosed battery box assembly enables the installation of parts in various regions within a frame of vehicle 100. For example, parts 230, 232, 234, and 236 are positioned between left movable frame member 202 and left midframe 102, while part 222 is positioned between right movable frame member 204 and right midframe 104. Additionally, parts 237 and 239 are mechanically coupled to cover 208, while part 212 is retained by left movable frame member 202 and right movable frame member 204 in cooperation with battery 206.

Thus, the instant examples illustrate instances in which parts are positioned above (e.g., parts 237 and 239), below (e.g., part 212), to the left (e.g., parts 230, 232, 234, and 236), and to the right (e.g., part 222) of battery box assembly 200. It will be appreciated that similar techniques may be used to position parts in front of or in back of battery box assembly 200 (e.g., along longitudinal centerline 120). Further, it will be appreciated that parts 212, 222, 230, 232, 234, 236, 237, and 239 are provided as example parts having associated mechanical coupling techniques. In other examples, fewer, additional, or alternative parts and associated mechanical coupling techniques may be used without departing from the present disclosure.

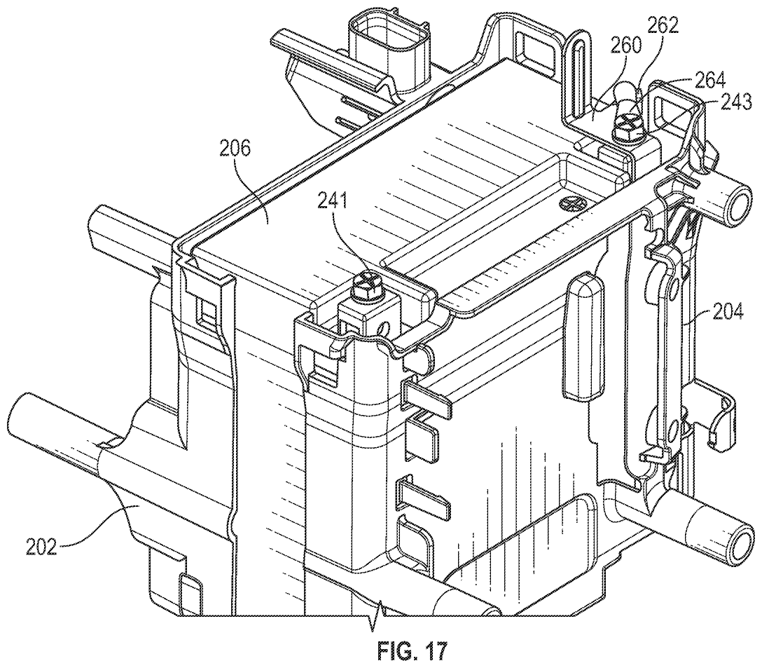

FIGS. 17-19 depict an example in which battery 206 has an associated busbar 260. As illustrated, busbar 260 is electrically and mechanically coupled to positive terminal 243 of battery 206. Busbar 260 may be sized and shaped to provide an area to which an alligator clip (not pictured) or other connector may be removably coupled to busbar 260, thereby enabling a vehicle operator to establish a temporary electrical connection to positive terminal 243 of battery 206. For example, busbar 260 may be used to jumpstart a vehicle (e.g., vehicle 100 in FIG. 1) that includes battery box 200.

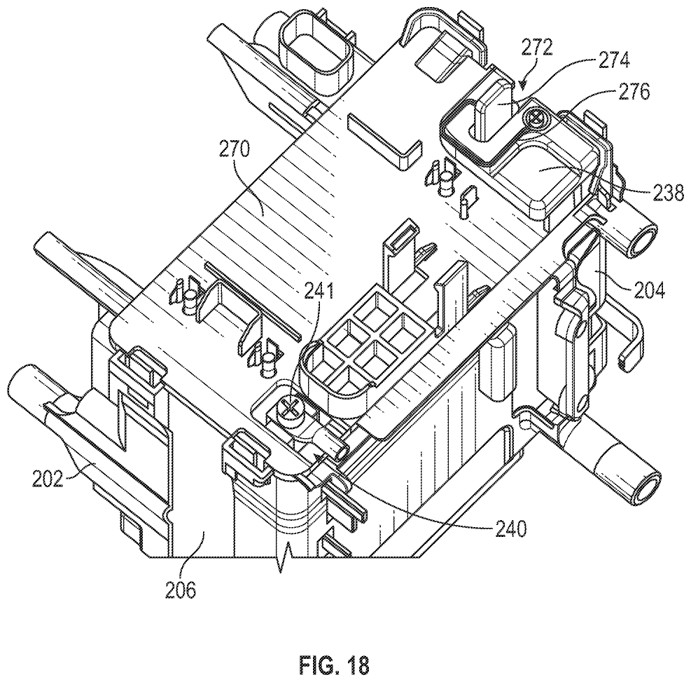

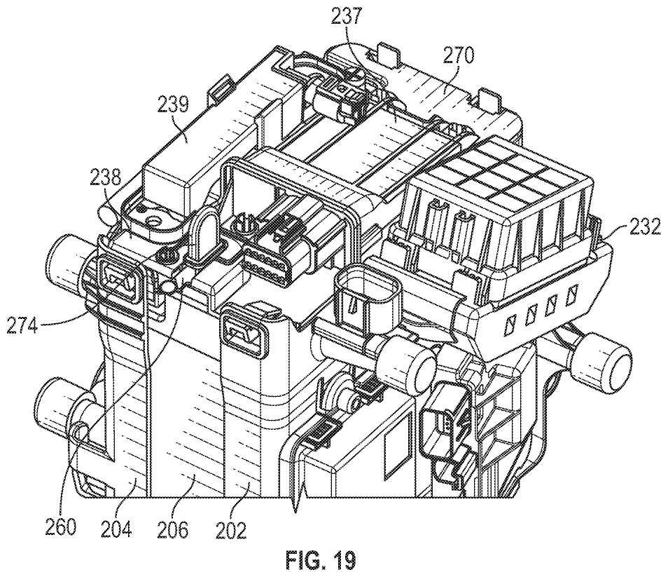

In an example, busbar 260 includes a locating or indexing feature that cooperates with battery 206, right movable frame member 204, cover 270 (FIGS. 18 and 19), and/or any of a variety of other elements of battery 206 and/or battery box assembly 200 to orient busbar 260 within battery box 200 (e.g., in relation to battery 206). As illustrated, busbar 260 includes feature 262 that orients positive cable 264 within battery box 200 when coupled to positive terminal 243 of battery 206.

With reference now to FIGS. 18 and 19, battery box assembly 200 includes cover 270. Aspects of cover 270 are similar to cover 208 discussed above and are therefore not redescribed in detail. As illustrated, cover 270 includes busbar feature 272, through which busbar 260 extends. Similar to cover 208, cover 270 includes positive terminal feature 238 and negative terminal feature 240, which covers positive terminal 243 and exposes negative terminal 241, respectively. Thus, an electrical connection to positive terminal 243 is permitted via busbar 260 when cover 270 is installed, while physical access to positive terminal 243 is restricted until an electrical connection to negative terminal 241 is disconnected (e.g., such that negative terminal feature 240 prevents removal of cover 270 while negative terminal 241 is electrically connected). Similarly, during reassembly, an electrical connection to positive terminal 243 may be reestablished prior to installation of cover 270, as access to positive terminal 243 is restricted after cover 270 is installed.

In addition, safety cap 274 is provided, which is sized and shaped to cover busbar 260 when busbar 260 is not in use. Thus, safety cap 274 may prevent inadvertent electrical contact with busbar 260. Safety cap 274 is tethered to cover 270 via tether 276, though it will be appreciated that any of a variety of additional or alternative retention mechanisms may be used. For example, safety cap 274 may instead be tethered to one of movable frame members 202 or 204, such that it may remain installed even after removal of cover 270. Alternatively, or additionally, cover 270 may be formed to include a feature having a size and shape similar to busbar 260, such that the feature may retain safety cap 274 when it is removed from busbar 260.

The following clauses are provided as example aspects of the disclosed subject matter:
1. A battery support for a battery, comprising: a first frame; a second frame spaced apart from the first frame to define a cavity; and a movable frame member positionable in the cavity and comprising a first interface configured to interface with a corresponding second interface of the first frame when the movable frame member is moved in a first direction toward the first frame; wherein the movable frame member cooperates with the second frame to define a battery cavity sized to receive the battery and to restrict a movement of the movable frame member in a second direction opposite the first direction when the battery is received by the battery cavity.
2. The battery support of clause 1, further comprising: a cover that mechanically couples to the movable frame member to retain the battery in the battery cavity in a third direction angled relative to the first direction.
3. The battery support of clause 2, wherein the cover further comprises: a positive terminal feature positioned to cover a positive terminal of the battery; and a negative terminal feature that restricts removal of the cover when a negative terminal of the battery is electrically connected.
4. The battery support of any one of clauses 1-3, wherein: the movable frame member is a first movable frame member; the battery box assembly further comprises a second movable frame member comprising a third interface configured to interface with a fourth interface of the second frame when the second movable frame member is moved in the second direction toward the second frame; and the first movable frame member and the second movable frame member cooperate to define the battery cavity and to restrict a movement of the second movable frame member in the first direction when the battery is received by the battery cavity.
5. The battery support of clause 4, further comprising a lower battery support supported by the first movable frame member and the second movable frame member, the lower battery support positioned to restrict movement of the first movable frame member in the second direction and the second movable frame member in the first direction.
6. The battery support of any one of clauses 1-5, further comprising a lower battery support supported by the movable frame member and the first frame to restrict movement of the movable frame member in the second direction.
7. The battery support of any one of clauses 1-6, wherein the first interface comprises a peg and an isolator.
8. The battery support of any one of clauses 1-7, wherein: the first interface includes a peg; and the second interface includes an isolator, the isolator and the peg cooperating to couple the movable frame member relative to the first frame.
9. A vehicle having a battery, comprising: a plurality of ground engaging members; a frame supported by the plurality of ground engaging members, including: a first midframe having a first interface defined on an interior side of the first midframe; and a second midframe, wherein the first midframe and the second midframe are on opposing sides of a longitudinal centerline of the vehicle; and a movable frame member comprising a second interface configured to interface with the first interface of the first midframe when the movable frame member is moved in a first direction toward the first midframe and away from the longitudinal centerline; wherein the movable frame member cooperates with the second midframe to define a battery cavity sized to receive the battery and to restrict a movement of the movable frame member in a second direction opposite the first direction when the battery is received by the battery cavity.
10. The vehicle of clause 9, further comprising: a cover that mechanically couples to the movable frame member to retain the battery in the battery cavity in a third direction angled relative to the first direction.
11. The vehicle of clause 10, wherein the cover further comprises: a positive terminal feature positioned to cover a positive terminal of the battery; and a negative terminal feature that restricts removal of the cover when a negative terminal of the battery is electrically connected.
12. The vehicle of any one of clauses 9-11, wherein: the movable frame member is a first movable frame member; the vehicle further comprises a second movable frame member comprising a third interface configured to interface with a fourth interface defined on an interior side of the second midframe when the second movable frame member is moved in the second direction toward the second midframe; and the first movable frame member and the second movable frame member cooperate to define the battery cavity and to restrict a movement of the second movable frame member in the first direction when the battery is received by the battery cavity.
13. The vehicle of clause 12, further comprising a lower battery support supported by the first movable frame member and the second movable frame member, the lower battery support positioned to restrict movement of the first movable frame member in the second direction and the second movable frame member in the first direction.
14. The vehicle of any one of clauses 9-13, further comprising a lower battery support supported by the movable frame member and the first frame to restrict movement of the movable frame member in the second direction.
15. The vehicle of any one of clauses 9-14, wherein the second interface comprises a peg and an isolator.
16. The vehicle of any one of clauses 9-15, wherein: the second interface includes a peg; and the first interface includes an isolator, the isolator and the peg cooperating to couple the movable frame member relative to the first midframe.
17. A battery support for a battery, comprising: a first movable frame member; a second movable frame member that cooperates with the first movable frame member to define a battery cavity sized to receive the battery; and a cover that mechanically couples to the first movable frame member and the second movable frame member to retain the battery within the battery cavity, wherein the cover includes: a positive terminal feature positioned to cover a positive terminal of the battery; a negative terminal feature that restricts removal of the cover when a negative terminal of the battery is electrically connected; and a busbar feature configured to permit a busbar to extend from the battery cavity, thereby enabling an electrical connection to the positive terminal of the battery via the busbar when the cover is coupled to the first movable frame member and the second movable frame member.
18. The battery support of clause 17, further comprising a safety cap tethered to the cover, wherein the safety cap is sized and shaped to be mechanically coupled to the busbar.
19. The battery support of any one of clauses 17-18, further comprising the busbar, wherein the busbar is electrically coupled to the positive terminal of the battery.
20. The battery support of clause 19, wherein the busbar includes an indexing feature to orient, within the battery support, at least one of: the busbar; or a positive cable electrically coupled to the positive terminal of the battery.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A battery support for a battery, comprising:
a first midframe of a vehicle;
a second midframe of the vehicle spaced apart from the first frame to define a cavity, wherein the first midframe and the second midframe each extend along a longitudinal centerline of the vehicle; and
a movable frame member positionable in the cavity and comprising a first interface configured to interface with a corresponding second interface defined on an interior side of the first midframe when the movable frame member is moved in a first direction toward the first frame;
wherein the movable frame member cooperates with the second frame to define a battery cavity sized to receive the battery and to restrict a movement of the movable frame member in a second direction opposite the first direction when the battery is received by the battery cavity.

2. The battery support of claim 1, further comprising:
a cover that mechanically couples to the movable frame member to retain the battery in the battery cavity in a third direction angled relative to the first direction.

3. The battery support of claim 2, wherein the cover further comprises:
a positive terminal feature positioned to cover a positive terminal of the battery; and
a negative terminal feature that restricts removal of the cover when a negative terminal of the battery is electrically connected.

4. The battery support of claim 1, wherein:
the movable frame member is a first movable frame member;
the battery box assembly further comprises a second movable frame member comprising a third interface configured to interface with a fourth interface of the second frame when the second movable frame member is moved in the second direction toward the second frame; and
the first movable frame member and the second movable frame member cooperate to define the battery cavity and to restrict a movement of the second movable frame member in the first direction when the battery is received by the battery cavity.

5. The battery support of claim 4, further comprising a lower battery support supported by the first movable frame member and the second movable frame member, the lower battery support positioned to restrict movement of the first movable frame member in the second direction and the second movable frame member in the first direction.

6. The battery support of claim 1, further comprising a lower battery support supported by the movable frame member and the first frame to restrict movement of the movable frame member in the second direction.

7. The battery support of claim 1, wherein the first interface comprises a peg and an isolator.

8. The battery support of claim 1, wherein:
the first interface includes a peg; and
the second interface includes an isolator, the isolator and the peg cooperating to couple the movable frame member relative to the first frame.

9. A vehicle having a battery, comprising:
a plurality of ground engaging members;
a frame supported by the plurality of ground engaging members, including:
a first midframe having a first interface defined on an interior side of the first midframe; and
a second midframe, wherein the first midframe and the second midframe are on opposing sides of a longitudinal centerline of the vehicle; and
a movable frame member comprising a second interface configured to interface with the first interface of the first midframe when the movable frame member is moved in a first direction toward the first midframe and away from the longitudinal centerline;
wherein the movable frame member cooperates with the second midframe to define a battery cavity sized to receive the battery and to restrict a movement of the movable frame member in a second direction opposite the first direction when the battery is received by the battery cavity.

10. The vehicle of claim 9, further comprising:
a cover that mechanically couples to the movable frame member to retain the battery in the battery cavity in a third direction angled relative to the first direction.

11. The vehicle of claim 10, wherein the cover further comprises:
a positive terminal feature positioned to cover a positive terminal of the battery; and
a negative terminal feature that restricts removal of the cover when a negative terminal of the battery is electrically connected.

12. The vehicle of claim 9, wherein:
the movable frame member is a first movable frame member;
the vehicle further comprises a second movable frame member comprising a third interface configured to interface with a fourth interface defined on an interior side of the second midframe when the second movable frame member is moved in the second direction toward the second midframe; and
the first movable frame member and the second movable frame member cooperate to define the battery cavity and to restrict a movement of the second movable frame member in the first direction when the battery is received by the battery cavity.

13. The vehicle of claim 12, further comprising a lower battery support supported by the first movable frame member and the second movable frame member, the lower battery support positioned to restrict movement of the first movable frame member in the second direction and the second movable frame member in the first direction.

14. The vehicle of claim 9, further comprising a lower battery support supported by the movable frame member and the first frame to restrict movement of the movable frame member in the second direction.

15. The vehicle of claim 9, wherein the second interface comprises a peg and an isolator.

16. The vehicle of claim 9, wherein:
the second interface includes a peg; and
the first interface includes an isolator, the isolator and the peg cooperating to couple the movable frame member relative to the first midframe.

17. A battery support for a battery, comprising:
a first movable frame member;
a second movable frame member that cooperates with the first movable frame member to define a battery cavity sized to receive the battery; and
a cover that mechanically couples to the first movable frame member and the second movable frame member to retain the battery within the battery cavity, wherein the cover includes:
a positive terminal feature positioned to cover a positive terminal of the battery;
a negative terminal feature that restricts removal of the cover when a negative terminal of the battery is electrically connected; and
a busbar feature configured to permit a busbar to extend from the battery cavity, thereby enabling an electrical connection to the positive terminal of the battery via the busbar when the cover is coupled to the first movable frame member and the second movable frame member.

18. The battery support of claim 17, further comprising a safety cap tethered to the cover, wherein the safety cap is sized and shaped to be mechanically coupled to the busbar.

19. The battery support of claim 17, further comprising the busbar, wherein the busbar is electrically coupled to the positive terminal of the battery.

20. The battery support of claim 19, wherein the busbar includes an indexing feature to orient, within the battery support, at least one of:
the busbar; or
a positive cable electrically coupled to the positive terminal of the battery.
